(19) United States
(12) Patent Application Publication
(10) Pub. No.: US 2011/0067581 A1
(43) Pub. Date: Mar. 24, 2011

(54) GRIDDLE TOP HAVING GROOVES FOR FAT DRAINAGE

(76) Inventor: Daniel Janocha, Wurzburg (DE)

(21) Appl. No.: 12/785,443

(22) Filed: May 22, 2010

(30) Foreign Application Priority Data
May 22, 2009 (DE) 10 2009 022 411.4

(51) Int. Cl. A47J 37/06

(52) U.S. Cl. 99/422

(57) ABSTRACT

A griddle top for the fast griddling of a plurality of substantially cylindrically-shaped foods, includes a grill plate, which is disposed on a grill or another heat source, and in which a plurality of grooves are formed, the channels including three approximately flat strips, which are connected at their longitudinal edges to form an upwardly open profile, with at least one piece of food being in contact on at least two mutually spaced, elongated portions of its outer skin, or surface, with one of the three strips of a channel.

### BACKGROUND OF THE INVENTION

1. Technical Field of the Invention

The present invention relates, generally, to a griddle top for the fast griddling of a plurality of sausages or plate-shaped foods, comprising of a grill plate, which is disposed on a grill or other heat source, and in which a plurality of grooves are formed.

2. Description of the Prior Art

Grilling is an old and very well known method for cooking sausages or similarly shaped foods, elongated-shaped foods, such as fish, courgettes, or so-called “spits”, i.e. cuts of meat and/or vegetables speared on a skewer, but also plate-shaped foods, such as steaks. To this end, each food item is fixed above, and at a small distance from, a heat source, which radiates heat thereon and thereby heats the food.

The grilling process is explained below with reference to a small sausage, but in principle, the grilling process, as explained, also applies to all other foods.

Heat energy is transmitted to the sausages until they are adequately cooked through to their core. Since the amount of heat acting on the core region has passed through the outer zones of the sausage section, more heat acts on the outer zones, and to an elevated degree on the outer skin, of the sausage than on its interior.

Consequently, the heat is not entirely uniformly distributed, which within certain limits is considered to provide an interesting flavor and is therefore welcome. Ideal cooking is classified as when the outer skin of the sausage has assumed a “golden brown” color. This golden brown color results from a very thin fat layer on the skin of the sausage, and by the penetration of fat into the upper region of the sausage skin, which hardens there.

A problem here is that, depending on the consistency of the sausage or else of another food, water and, in particular, an excess of fat can exude. The fat, not required for ideal browning, in the heated state, forms a liquid. When this drips into a flame, which serves as a heat source, it can also ignite. In the region of the flames, the food is overheated and thereby burnt to a greater or lesser extent. These burnt portions are regarded as having an extremely unwelcome taste. Because of the overheated fats that are applied to, and to some extent penetrate into the food, and are difficult for the human digestive system to break down, and include too many harmful metabolic products, they are also harmful to human health.

To achieve ideal browning during grilling, the sausage must be mechanically fixed at a certain distance from the heat source. This object is made difficult by the fact that the heat source generally extends over an area, and therefore only subjects the sausage to radiant heat from a single direction, since heat sources that are operated by incineration of wood, charcoal or other solid fuels are generally horizontally oriented to distribute the fuel uniformly on a surface.

Heat sources for liquid or gas fuels, such as gas burners or oil burners, are also arranged horizontally, in order that, in addition to the radiant heat, the air heated by the heat source, which automatically rises, can be used for additional heating of the sausage by convection. The same applies to electrically operated heat sources, such as heating plates, infrared bars or infrared radiators. The sausage is thus not only heated by radiant heat, but also by contact with the heated air.

For each type of these planar heat sources, there is, thus, the additional task that the sausage is only subjected to radiant heat from one direction, which is only distributed on a single strip of limited width on the outer skin of the sausage and only optimally cooks this strip. The remainder is still close to its original state in terms of color and consistency. The cooking is therefore not complete. The sausage must therefore be continually turned.

To permit comparatively simple turning of the sausages, there exists in the prior art equipment for grilling or griddling a sausage, which comprises a horizontally disposed plane, which is interrupted by numerous orifices and on which the sausages can be further rolled.

In a very simple case, the cooking surface is a grid, on the top side of which the sausages can be laid and on the underside of which the heat source acts. Radiant heat and heated air pass through the openings of the grid to the sausages. In general, the rods of this grid consist of metal, so that the grid is stable despite the high temperatures that are required.

A considerable disadvantage of this simple grilling grid is that the metal rods are so strongly heated by the radiant heat of the fire that they heat the sausages lying thereon in this region to the extent that fat emerging is blackened and leaves behind a black stripe on the sausage. In an extreme case, the adjacent outer skin of the sausage or even broader zones of the sausage are blackened. The blackened regions are—as mentioned—optically unattractive and, nutritionally, extremely disadvantageous, since regular consumption of overheated fat and overheated meat can demonstrably be carcinogenic.

To limit this problem, in the prior art the Federal Republic of Germany Utility Model No. DE 20 2004 004 745 describes a grill, the grill bars of which are hollow and through which air flows, reducing their outer temperature. However, there remains with this grilling appliance the disadvantage that the sausages are still primarily heated from only one single direction.

A further disadvantage of this grill is that fat emerging from the sausages can drip into the flames flickering below, where it is burnt. The resulting jet flames lead to impermissible heating of regions of the outer skin and thereby generate further excessively heated, blackened and possibly carcinogenic portions.

To prevent the dripping of fat onto the heat source, U.S. Pat. No. 3,842,726 describes a griddle into which a multiplicity of parallel running grooves or channels have been introduced, so that small ridges are created between these grooves, on which the sausage lies. During heating, fat drips therefrom into the channels and can flow away without passing into the heat source.

A considerable disadvantage of this device is that, by direct contact with the hot plate, the sausage is very much more strongly heated in the regions in which it lies on the ridges than in the other regions, so that this grill appliance, too, heats the sausages non-uniformly. Even with a low exceeding of the cooking time and/or cooking temperature, the non-uniform heating is visible as cross-stripes on the sausage.

However, this nutritionally hazardous grilling result is not classified as a disadvantage by the aforementioned U.S. patent application, but—on the contrary—is even desirable. The prior art patent classifies the elevations between channels as ridges or crests and in column 2, lines 49-51, specifically mentions that the area of these ridges is smaller than the area of the channels, the ridges are thus narrower than the channels. This corresponds to “crisp cooked strips” or “charred stripes” as a result of grilling.

According to this latest knowledge of nutritional science, it is now undisputed that the continuous consumption of crisp cooked or charred meat is a health risk.

A further disadvantage for this grill is that the sausage is only heated from a single direction. With careful heating appropriate to the food, there results in the longitudinal direction a strip along the sausage consisting of very small optimally cooked rectangles, which lay on the ridges, with already precooked larger rectangles between them, and not yet adequately heated regions on the remaining surface.

By virtue of the elasticity of the sausage, it can be pressed onto the ridges so that the width of this strip can be somewhat enlarged. Depending on the ratio between the elasticity and diameter, however, six to eight turns of the sausage are necessary in practice.

The German unexamined laid-open Patent Application No. DE 100 07 283 also describes a grilling device that consists of a plate with a plurality of approximately parallel channels. In one embodiment, this device is also equipped with side walls at the edge of the grill plate, and in that case not only looks like a griddle pan, but also, strictly speaking, cooks the sausages by griddling, not by grilling. This device is limited by the significant disadvantage that the sausage is only heated in the longitudinal direction along a single strip and within this strip also only at the optimum temperature in regions spaced from one another.

### SUMMARY OF THE INVENTION

It is, therefore, an object of the invention to provide a device for griddling sausages or approximately plate-shaped foods on a grill, which heats both sausages as well as plate-shaped foods on a larger portion of their surface than in the prior art, as uniformly as possible and free of charred portions, and thereby regulates the amount of fat and other liquids emerging from the food, and requires a very much lower number of mechanical movements on the grill for complete cooking.

To achieve this object, the invention proposes that the channels are comprised of three strips, which are connected at their longitudinal edges to form an upwardly open profile and at least one sausage is in contact on at least two mutually spaced, elongated portions of its outer skin with one of the three strips of a channel in each case.

To this end, it is a prerequisite that the sausages to be heated are inserted in the longitudinal direction in the channels of the griddle plate, which of course is only possible if the width of the channels is at least as large as the largest diameter of the sausage.

During griddling of sausages, the griddle top according to the invention, by virtue of its shape, offers special and unique relationships between the food to be cooked and the heated surface and combines the advantages of griddling with the advantages of grilling, without their risks.

Of the surface of the food facing downwards towards the heat source, of the order of about a half has direct contact with the heated surface. The situation of the food, in the interior of the contact surfaces, has something in common with the situation of a food item in a frying pan. By virtue of the direct contact, a high degree of thermal energy is transmitted, so that not only the outer regions of the food are cooked, but also the regions deeper within the food.

Between the food and the heated surface is located fat and water, which have exuded from the food. By virtue of its flowability and its good thermal conductivity, it forms thermal bridges for the transfer of energy from the heat source to the food—specifically also in the regions where the food and heated surface are not in contact but only very close together. In these regions, however, the fat is also protected against being unduly heated, i.e., up to the temperature range in which unhealthy trans fatty acids form.

Scientific studies have confirmed that foods with high contents of trans fatty acids are a hazard to health. The disadvantageous effects of trans fatty acids are increased risk of cancer, elevated blood pressure, reduced insulin sensitivity and, as a result, diabetes and various allergies.

High consumption of trans fatty acids is, in particular, a cause of excessive LDL levels in the blood serum, (low-density lipoprotein, known colloquially as “bad” cholesterol) and a decrease in the HDL level (high-density lipoprotein, known colloquially as “good” cholesterol), which can lead to arteriosclerosis and, consequently, to an elevated risk of a heart attack or stroke.

In particular, sausages often contain fats that have been partly hardened in their manufacturing process. Further heating transforms them into hardened trans fatty acids.

Studies have shown that adults should not consume more than two to three grams of trans fatty acids per day. Consumption of five grams of trans fatty acids daily increases the risk of a coronary disease by 25%.

This amount is dramatically exceeded by sausages that have been grilled with devices according to the prior art and have several dark-brown or black-brown stripes.

But it is also known that conventional griddling, i.e. heating by a very large-area contact between the food and heated surface, can easily result in overheating, particularly in the core regions of large surfaces.

The reason for this is either that too-hot fat is present in excess or the amount of fat is so low that the food comes so near to the heated surface that it, and therefore also the—low—amount of fat, is overheated.

Experience has shown that, during griddling, the risk of overheating is lowest at the edge regions of a food item.

The present invention uses this effect in that it has a very large number of narrow surfaces with direct contact between the food and heated surface.

A further feature of the present invention that is just as important is that, between the surfaces having in each case direct contact, a further surface is arranged, by means of which the food assumes a low distance from the heated surface.

In these regions, two processes take place in parallel: First, these regions are subjected to radiant heat. They are thus grills, as a result of which the welcome golden brown coloration and the formation of a thin crust are supported.

The second, and also welcome effect, is the transportation of excess fat. It can flow along the approximately triangular-profiled cavities between two adjacent strips and the sausage. By this means, excess amounts of fat are transported away within the channel. They pass either to a region with a fat deficit and compensate for this deficit in that the required sub-amount is sucked in and sucked up. Excess fat flows in the approximately triangular-profiled cavities and out of the critical regions.

A characterizing feature of the present invention is therefore the form of the channels. Each channel of a griddle according to the invention comprises three approximately flat strips that are arranged at angles to one another.

When the largest diameter of the sausage is smaller than the width of the channel, then it will lie, by at least at two elongated regions of its outer skin, on one strip of the channel in each case. And even when the central strip of the channel is relatively narrow in comparison to the width of the adjacent wall strip, and the diameter of the sausage is significantly larger than the width of the central strip, the sausage is in contact with two strips of the channel. By means of this areal contact, it is optimally cooked on two elongated strip-shaped regions of its outer skin.

In these regions, the heat is transmitted to the sausages, not by radiation, but by convection of the thermal energy directly to the outer surface of the sausage from the usually metal material of the channel.

Unlike processes of the prior art, the sausages are thus not only cooked in a single strip-shaped region, but—depending on the ratio of their diameter to the width of the channel—are optimally cooked at least along two strips, or even along three strips.

When the width of the channel approximately corresponds to the diameter of the sausage and the angle between the central strip and the two adjacent wall strips is greater than 90 degrees, and the central strip is somewhat narrower than the diameter of the sausage, it even lies on each of the three strips. In that case, the sausage, by virtue of its elasticity, is in contact with the surface of the channel, i.e., on three strip-shaped regions, which run parallel to its longitudinal axis.

The regions lying there between are not yet properly cooked but only heated by radiant heat. They only have to be brought into contact with the wall strips and/or the central strip of the channel by a slight rotation about their longitudinal axis. The former “contact regions,” which are already almost properly cooked are then post-grilled somewhat by radiant heat. However, the number of turns necessary for this is only half of that of other known flat griddle plates, or—if the diameter is optimally adapted—only a third. By this means a clear reduction of the necessary griddling time is achieved.

Another advantage is that, within each strip, the cooking result is better than with grill appliances of the prior art, which can only achieve an optimum result in the region of the support on the grill.

Another already mentioned advantage of the trapezoidal channel for griddling is that, between the strip-shaped regions with direct contact to the sausage in the channel, narrow elongated zones form, in which a small cavity occurs between the channel and the sausage. This cavity is filled with fat and/or moisture, which exudes from the sausage. Additional amounts of liquid fat or other liquid are distributed in the channel. If the channel is slightly inclined, then these excess amounts of liquid flow away along the channel.

Even if the sausage is pressed with elevated force into the channel, some liquid will always remain in the two angles between the central strip of the channel and the two adjacent wall strips. This small amount of liquid is always welcome to serve as lubricant for a slight rotation of the sausage on the next turning, and to obtain the desired golden brown consistency of the final grilled sausage surface.

In a further advantageous embodiment, the transport away of excess amounts of fat is increased by an inclination of the channel.

The inclined channels can pass into a collecting channel that extends transversely thereto and is also inclined and, in this manner, ensures that the liquids exuding from the sausage during griddling, or added thereto externally, are further transported away.

For sausages with a particularly high fat content, a particularly high capacity for removal of unrequired amounts of fat is desirable. In this case, it is expedient to choose to have the central strip very small in ratio to the diameter of the sausage. In an extreme case, the central strip can be so narrow that it is comprised of only of the curvatures of the transition between the two wall surfaces.

Then the sausage no longer lies on the central strip but only on the two wall strips. Thereby two cavities are no longer formed below the sausage, but only a single one, which, however, has a larger cross-section, whereby unrequired amounts of fat and moisture can flow away more easily.

In practice, the profile of the channels is mostly trough-shaped or—in the case of an extremely narrow central strip—approximately V-shaped. The angle between the central strip and the two edge strips is thus in a range between about 100 and 140 degrees.

However, it is entirely conceivable that for particular applications this angle could also have a different magnitude, and even be smaller than 90 degrees, so that the angle has the profile of a groove with an undercut. In this case, only a relatively highly elastic sausage can be introduced into the groove-shaped channel. The advantage then is that it is retained therein and cannot be so easily moved out of the channel again, e.g. by wind and/or shaking. This can be an advantage, e.g., in the application on rocking ships, in aircraft or in trains.

It is also conceivable that only one of the two angles between the central strip and wall strip is smaller than 90 degrees. Then very thin sausages can be pressed into this small angle, where they can be cooked to completion relatively quickly, since the width of the strip is very large in ratio to its diameter. In the same channel, relatively larger sausages can then also be processed. The advantage of this configuration is, thus, a relatively large bandwidth of the diameter of the sausage to be cooked.

It is also conceivable that the left wall strip has a different width from the right wall strip, so that the central strip does not run evenly, but is inclined. That can be an advantage, e.g., when, during heating of the sausage, in addition to the sausage, other liquids are secreted, which should flow away relatively very quickly, and should thus not be distributed on the surface of the central strip, but should concentrate as fast as possible in an edge region of the strips.

In a particularly practical configuration, the width of the central strip is approximately ¼ of the width of the wider adjacent wall strip.

In practice, it is generally advantageous if, between the central strip and the two adjacent wall strips, a curved region is inserted. Then the surface of the central strip merges continuously into the wall strip and does not form sharp edges, which makes the inclination of the channel considerably simpler.

A further advantage is that such a configuration, with relatively low effort, can be produced by multiple folding of a metal sheet.

Where there is an increased amount of liquid fat or other fluids exuding from the heated sausage, it is expedient that the channel for griddling runs inclined along its longitudinal axis with respect to the horizontal. Then all the liquids collect at one end so that the sausage is still fried and not boiled in the liquid.

In one embodiment of the present invention, it is preferred that all channels for griddling are connected to a continuous collection channel, which catches the fats and liquids emerging from the channels. To avoid a liquid accumulation in this collection channel, it is expedient that it is also inclined. If the accumulating fat or liquid amounts are very large, it may be appropriate to arrange a collection tank at the end of the inclined collection channel, in which the liquid collects, from where it can be disposed of.

So that the fat and liquid amounts from the channels only collect in the collection channel, its free end, in each case, should be closed by means of a transverse wall.

As a further embodiment, the present invention proposes that the griddle plate and the collection channel together form a closed surface. In this manner, air that is heated below the collection channel and the channels for griddling does not flow out through the openings between the griddle plate and the collection channel, but is distributed below the channels, whereby the efficiency of the griddle top is improved.

As mentioned, it should be preferred that the width of the griddle channels approximately corresponds to the largest diameter of the sausages to be grilled, because then the sausages lie with three regions of their outer skin against one strip in each case of the trapezoidal-channel-shaped griddle plate according to the invention.

To be able to optimally griddle sausages of various diameters with a single griddle plate, an embodiment is appropriate that has channels of various diameters in a griddle plate, so that “thin” and “thick” sausages can be grilled simultaneously.

However, the application of a griddle top according to the present invention is not restricted to sausages, but all other similarly shaped foods can be grilled, foods that are generally elongate in shape, e.g., sausages, fish, gherkins, carrots, sirloin strips and the like. For optimum griddling results, it is, as widely mentioned, best if the food to be grilled is in areal contact with the griddle plate. If the food to be griddled does not have a precisely cylindrical cross-section, such as a sausage, but tapers, such as a fish or carrot, it is expedient to provide a correspondingly tapering channel for this. By this means, e.g., the tail region of a fish can be optimally grilled, since it is also in areal contact with the griddle plate.

For particularly good adaptation, it is also conceivable that the width of the channel is designed appropriate to the respective effective diameters of the food to be griddled. In an idea case, the silhouette of the food to be griddled corresponds to the silhouette of the channel. For this, the channel can have, e.g., the largest width in the center.

For the purpose of minimizing the energy consumption of the griddle top, it is appropriate for the griddle plate to cover the heat source completely, so that as much radiant heat as possible, and as much convection heat as possible, is utilized. For this purpose, the present invention proposes closing as far as possible the entire gap between the outer edges of the heat source and the griddle plate.

The griddle plate appropriately comprises a material with particularly high thermal conductivity, so that the thermal energy applied from below is transferred as completely as possible to the food to be griddled and, for which reason, the griddle plate is usually made of metal, in practice. It is expedient to use steel but also aluminium. It can be formed into, e.g., griddle tops for single use.

The shape of the channels can be produced by casting into a form or by pressing sheet metal. However, both processes require corresponding forms, which make the end product relatively expensive, particularly in medium and small production rates.

In particular, when optimum adaptation of the channel width to the sausages to be grilled is sought, grooves with different widths are necessary, for which purpose a large number of forms of different widths should be kept ready. If only single pieces or small series are produced with these forms, their costs make up an increasingly important proportion. The invention therefore proposes, as an alternative production form, that the griddle plate should be made by folding sheet steel. It can then be welded to the collection channel. Likewise, the transverse walls can be welded in as a closure of the channels and collection channel.

In practice, in most cases, the channels on the griddle plate will run parallel to one another and have a constant profile along their length. For this application case, it is possible, in order to adapt to various rectangular heat sources with different dimensions, to configure cover plates, with which the openings between the hot surface and the griddle plate can be closed. These cover plates have at their upper side an approximately meandering profile, which corresponds to the trapezoidal profile of the channels of the griddle plate. These cover plates can then be applied beyond the width of the griddle plate at any desired point, so that the griddle plate can be placed on heat sources of any desired with a lateral air closure. To this end, two cover plates of this type can be mounted parallel to one another and spaced from one another.

To close the remaining two openings between the griddle plate, the two cover plates and the heat source, the present invention proposes that each of these two openings can be closed by way of two cover plates, which more or less overlap, depending on the width of the heat source.

In a further embodiment, the present invention proposes that vertical cover plates are mounted circumferentially on the outer edge of the griddle plate, e.g. as strips angled from the sheet metal and two opposite angled regions are penetrated by at least one opening. From these openings, air rises, which has passed close to the griddle plate and thereby heated it. This effect is particularly clearly pronounced if the griddle plate is made of stainless steel, aluminium or another brightly lustrous metal, because radiant heat is thereby reflected and heat transfer, by convection, becomes increasingly important.

These air outlet openings can be introduced and utilized both in the case of a griddle top with a strictly trapezoidal profile, as well as with alternatives, with inclined channels and griddle plates inserted therebetween and having an approximately trapezoidal profile.

Comprehensive grilling trials have shown that the guidance of the air rising from the heat source is of great importance for the rapid and efficient setting of an optimum grilling and griddling temperature. The trials were all performed with a griddle plate in which the trapezoidal channels according to the invention have been introduced and into which the sausages have been inserted for cooking. By using the same heat source with an open flame for all three variants and by the insertion of an equal amount of fuel, it was ensured that the generated amount of heat was the same in all cases, within the limits of practical accuracy.

In the first attempt, a griddle plate was used which does not have any perpendicular supporting walls at its outer edges. Instead, the channels lay directly on a grid above the heat source. With this configuration, various sausages were cooked and the time until optimum completion of the cooking process was noted as a comparison scale.

In a second alternative arrangement, vertically cover plates were mounted circumferentially on the outer edges of the griddle plate and welded to one another in an airtight manner, such that, seen from below, a box-like arrangement resulted, in which rising hot air could collect. By this means, the channels of the griddle plate no longer lay directly on the grid above the heat source but were approximately at a distance therefrom. In this arrangement, an approximately equal amount of heat as before was generated and emitted with the same amount and the same type of fuel. The sausages grilled thereon also corresponded to the first trial. As a result, it was determined that the grilling duration is only insignificantly shortened. From this it can be concluded that air that has collected in the box-like embodiment of the griddle top does not reach the expected high flow rate, but rather has an insulating effect, so that “trapping” the rising heated air in a box-like arrangement does not allow a significant increase in the amount of heat transferred to the sausages.

In a third trial therefore in the above-described box-like arrangement, the vertical circumferential surface is penetrated at two opposite edges by a large air opening in each case. With this, a significant reduction of the grilling time could be achieved. From this it can be concluded that a duct-like guidance of the heated air rising from the fire permits a significant increase in the amount of heat transferred to the foods from the heat source.

This advantageous embodiment can also be used in the alternative embodiment of the channels with flat strips and then strictly trapezoidal profiles. Then the two opposite vertical cover plates, not provided with an air opening, at the edge of the griddle plate are preferably of the same height, so that the griddle plate also assumes a horizontal position on a flat grill. Alternatively, the two air openings, or a plurality of smaller air openings separated from one another by ridges, can also be introduced into two mutually opposite trapezoidal vertical cover plates. Adjacent to these two trapezoidal cover plates are then a high cover plate and low cover plate, such that the entire griddle top takes on a desk-like form, which effects an inclined position of the channels and the griddle strips arranged therebetween on a horizontal grill. This inclination ensures that, even with a domed-shape of the strips from which the griddle channels are formed, an adequate removal of fat and others liquids exuded from the heated food is ensured.

The exemplary embodiment of a griddle top according to the present invention, as explained above, describes the application for fast cooking of sausages and other approximately cylindrical foods.

In another embodiment, approximately plate-shaped foods, e.g., steaks or escalopes can be cooked according to the teaching of the object, that is to say, heated on the surface evenly and free of charred portions; the amount of fat and other liquids exuding from the food being regulated.

If a griddle top according to the present invention is optimized entirely for the cooking of cylindrical foods, such as sausages, the ridge or the crest between the channels to receive the sausages is as narrow as possible, so that as many sausages as possible can be cooked on the available area of the grill.

In this variant, too, steaks or other plate-shaped foods, such as vegetarian rissoles, can be cooked by laying them over the ridges. However, this has the restriction that the foods only have direct contact with the heated surface on the possibly very narrow area of the crest. At this point, there is an elevated risk of overheating with the formation of black strips. These black strips are a frequent characteristic of steaks and other foods that have been cooked by grilling in the prior art. However, they are in contradiction with the object of the present invention, which requires a nutritionally optimum, i.e., uniform, heating.

The problem of the overheated strips can be solved by pushing the food further relatively frequently around the width of this crest and so it comes into contact with the heated surface with each sub-portion of its entire surface. However, the restriction is that the time proportion during which the area not lying on the crests is not subjected to radiant heat is relatively high, which should then be taken into account in the length of time spend on the crests. A further restriction is that a relatively accurate positioning is necessary, which cannot be controlled from above, since the contacting underside is not visible. The present invention therefore proposes, as an embodiment, that, between the channels, flat griddle strips are inserted, on which at least one plate-shaped food item can lie.

Then, fat exuding from the plate-shaped food can drip into the channels and there flow away. So that this flow is supported, the invention proposes that, in the embodiment with griddle strips, at least the channels are always slightly inclined with respect to the horizontal and at their lowest point pass into a collection channel.

Since, in this manner, the transport away of the excess fat is supported, the trapezoidal form of the channel profile can be somewhat more freely designed. The strips then no longer necessarily have to form a plane, but can also be slightly curved. If they are concavely curved towards the interior of the channel, the contact area of sausages laid in the channel is thereby enlarged. If the strips are convexly curved towards the interior of the channel, i.e., project into the channel in the manner of a bead, the contact area of the sausage is thereby reduced. By this means, variants in cooking are possible.

Despite this somewhat greater freedom in the design of the profiles, a good transport away of excess liquids is nevertheless ensured, because the channels in this variant are, in principle, always inclined.

It is then possible for a sausage to lie with only one elongated region of its outer skin on at least two of the three strips of a channel by pressing it by virtue of its elasticity against the form of the strips to the extent that it conformally bridges the transition between two adjacent strips.

This variant is particularly expedient when only very little fat usually emerges from the sausages, so that the drainage within the channel only requires a limited volume.

Of course, in the variant with griddle strips between the channels, a very strictly trapezoidal profile of the channels is possible and expedient. The strips are then flat so that a sausage inserted into the channels, by at least two mutually spaced, elongated regions of its outer skin, comes into contact with one of the three strips of a channel.

Irrespective of the chosen profile of the channel, a plate-shaped food item that, because of its size, cannot be placed within the channels can be cooked on the griddle strips. It is particularly expedient that the griddle strips are approximately as wide as the channels and extend parallel thereto. Then, as a process for fast grilling an approximately plate-shaped food item, it is an obvious step that it is heated during the first half of the entire cooking time, without being moved and is then moved transversely to the griddle strip by precisely the width of the griddle strip, and then, in a second step, during the second half of the entire cooking time, is heated again without moving it. In this way, each area of the surface of the food article comes once into direct contact with the heated surface. During this grilling takes place by radiant heat from the channel in the other region, which is not in contact. For one half of the surface, that effects a preheating upstream and, for the other half of the surface, a post-grilling downstream, so that over the entire surface, as cooking results, the desired golden brown coloring of a piece of meat can be achieved.

In this embodiment, too, a significant advantage of the cooking method according to the present invention, is that an excess amount of fat emerging from the food item is transported away via the channels and can no longer drip into an open fire nor remain too long below the food The risk of undesirable blackening of the food by fat, which drips into an open flame, where it burns and blackens the food with soot and/or is overheated, is thereby also eliminated as is the risk of burning by a large amount of excessively heated fat, which comes into direct contact with the food.

Rather, by virtue of a large number of griddle strips, it is achieved that the entire surface with a direct contact between the plate-shaped food and heated surface is subdivided into a relatively large number of narrow regions. As is known, the grilling result in the edge regions of a contact zone is relatively the best, so that an increase in this type of surface ensures, in principle, a better and nutritionally more advantageous grilling result.

In the embodiment with griddle strips between the channels, the invention provides—as already defined—that at least the channels are, in principle, inclined, preferably, however, the griddle strips are also designed so as to be inclined, so that exuding, excess amounts of fat cannot be deposited there during contact, but can flow away. To incline the griddle top with respect to the surface of a horizontal heat source, the invention proposes that, at the edge, and/or within the griddle plate, downwardly facing trapezoidal strips or segments of these strips are oriented perpendicular to the griddle, the lower edges of which are arranged in a plane, so that the central strip of the channels are inclined. These trapezoidal strips therefore ensure an inclination of the griddle top. In a similar way to a wedge, these strips ensure that the griddle top is somewhat further remote from the grill surface at one edge than at the opposite edge.

This trapezoidal strip can, in a very simple embodiment, be angled downwards, starting from two mutually opposite edges of the griddle top. To further increase the loading capacity of the griddle top during insertion and during turning of the food being grilled, it is also expedient to form such trapezoidal strips within the surface.

If the griddle top is made, e.g. of sheet metal by pressing, it is expedient to develop such trapezoidal strips within the surface double-layered and with a V-shaped profile, so that they can be co-formed in the same production step during pressing of the sheet-metal piece. In particular, for tray-shaped griddles that are only intended for single use, and therefore formed of relatively thin aluminium sheet, the shaping of a plurality of such trapezoidal supports within the griddle is mechanically advantageous since, despite the relatively low material thickness of the aluminum sheet, a desired “inclination” of the entire unit is ensured; not only directly after production but also after relatively long use with multiple turning of the item being grilled.

Other objects and features of the present invention will become apparent when considered in combination with the accompanying drawing figures which illustrate certain preferred embodiments of the present invention. It should, however, be noted that the accompanying drawing figures are intended to illustrate only certain embodiments of the claimed invention and are not intended as a means for defining the limits and scope of the invention.

### BRIEF DESCRIPTION OF THE DRAWING FIGURES

In the drawing, wherein similar reference numerals and symbols denote similar features throughout the several views:

FIG. 1 shows a plurality of griddle channels and a collection channel as a portion of a griddle plate according to the present invention; and,

FIG. 2 shows a desk-like griddle top with griddle strips and lateral air openings.

### DETAILED DESCRIPTION OF THE DRAWING FIGURES AND PREFERRED EMBODIMENTS

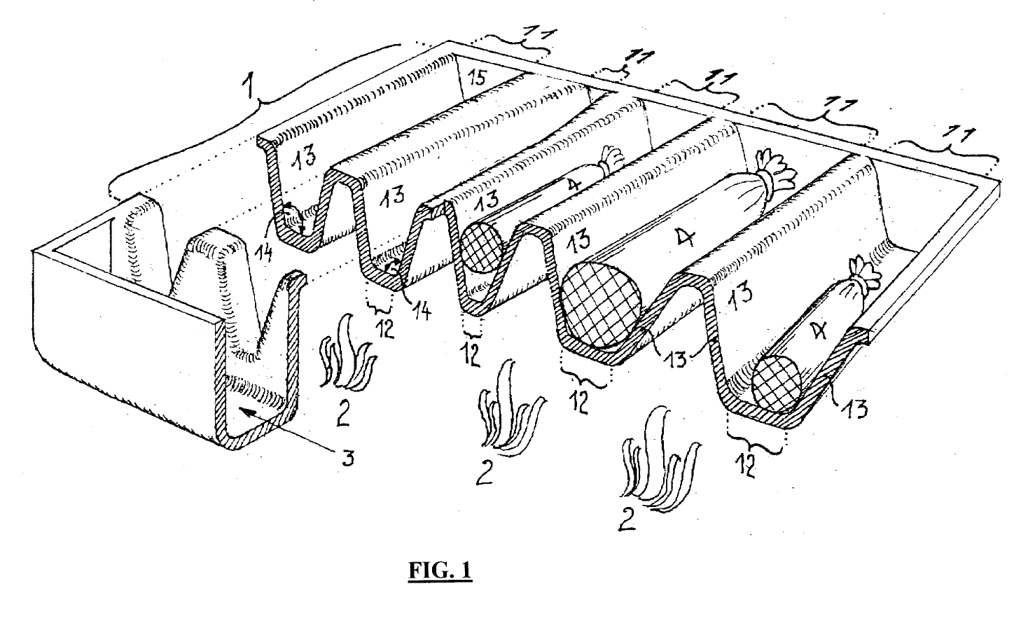

Turning now, in detail, to an analysis of the drawing figures, FIG. 1 shows a cutaway and perspective view of a plurality of channels 11 and a collection channel 3 as two portions of a griddle plate according to the invention. In the portion of the griddle plate 1 shown in the rear portion of FIG. 1, a total of five channels 11 are formed, which, in this exemplary embodiment, differ in each case in their width.

With the exception of the central channel 11, the central strip 12 of the other four channels 11 is about half as wide as the two adjacent wall strips 13. The two wall strips 13 are, in each case, of the same length and the angle 14 between the central strips 12 and the two adjacent wall strips 13 are about 110 degrees.

In the channel 11 shown in the frontal portion, a relatively thin sausage 4 is inserted, whose diameter is significantly smaller than the width of the channel 11. In FIG. 1, it is very clearly visible that the sausage 4 is only in contact with this channel 11 along two strips, specifically the central strip 12 and the right-hand one of the two adjacent wall strips 13. This makes it very readily clear that the contact surface of the sausage 4 on the griddle plate 1 is twice as large as with flat griddle plates of the prior art, in which the sausage is only in contact with a single strip.

In the second channel 11, seen from the front edge, the diameter of the sausage 4 is almost as large as the width of the channel 11. Consequently, the sausage 4 lies not only on the central strip 12 of the channel 11, but also on both wall strips 13. With this ratio of the diameter of the sausage with respect to the width of the channel, the contact surface of the sausage 4 is at least three times as large as in the case of flat griddle plates of the prior art.

For the ratios between the sausage diameter and channel width shown in the two frontmost channels, there still remains, between the contacting strips, a narrow region in which the sausage 4 is at a distance from the griddle plate 1. In these regions, fat and liquid can collect. In FIG. 1, it can be easily seen that the amount of fat that collects there during “further turning,” that is to say the rotation of the sausage 4 about its longitudinal axis, is entrained and then forms a thin film between the contact surface of the sausage in the channel 11 and the surface of the sausage 4.

In the central region of the illustrated five channels 11, the width of the central strip 12 is approximately ¼ of the width of the adjacent wall strips 13. The sausage 4 inserted in this channel has a diameter that is wider than the central strip 12, but smaller than the width of the channel 11. In this configuration, the sausage 4 is only in contact with the two wall strips 13, but not with the central strip 12. This configuration offers a particularly large space between the sausage 4 and the central strip 12, and is thus suitable for all cases in which a particularly large amount of exuding fat and liquid is to be expected. This configuration could be suitable in particular for griddling strongly water-containing vegetables, such as carrots and gherkins.

The penultimate channel 11 has a width that changes along its length. In the illustrated section, it has the same width as the adjacent channel 11 that is introduced at the very back; however, this channel becomes significantly narrower towards the outer edge. It is therefore suitable for griddling fish or other foods, such as carrots, which taper towards their end. The channel 11 shown at the very back serves for representing the angle 14 between the central strip 12 and the adjacent wall strip 13.

Below the illustrated griddle plate 1, three flames are drawn, which in each case symbolize a heat source 2.

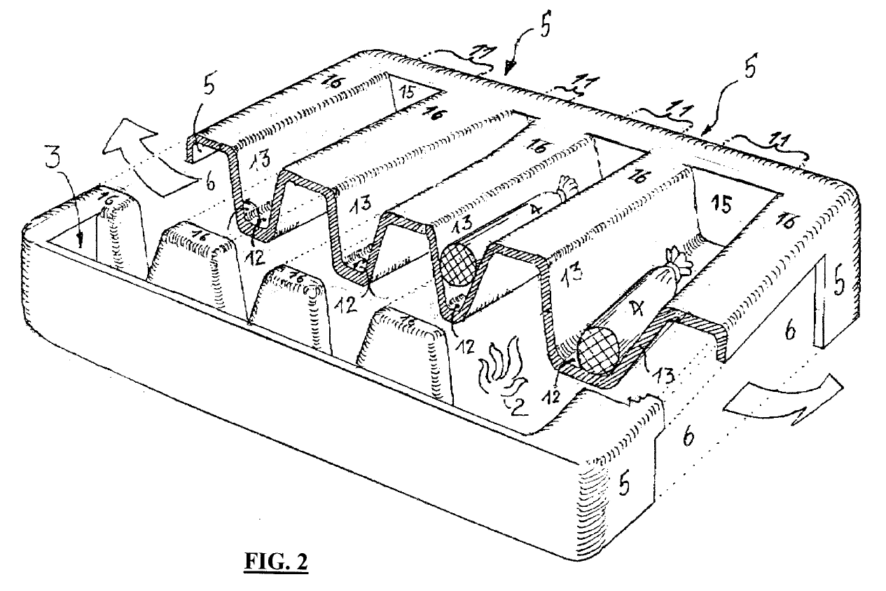

In the front portion of FIG. 2, a graphically cutaway portion of the collecting channel 3 is shown in perspective view. Consequently, it is very readily visible that the collection channel 3 is outwardly closed, so that no liquid fat can emerge. Inwardly towards the griddle plate 1, the collection channel 3 is provided with a plurality of trapezoidal openings, which in each case pass into a channel 11.

In FIG. 1, it can be clearly seen that as a result of a slight inclination of each channel 11, a liquid contained therein quickly flows into the collection channel 3 at the front edge. If the collection channel 3 is also inclined, then the liquid from this channel also rapidly flows out. So that the liquid only flows out in one direction, the free ends of the channels 1 are in each case closed via a transverse wall 15.

FIG. 2 shows an alternative embodiment of the griddle top according to the present invention, which is not only suitable for cooking approximately cylindrical foods, but also for plate-shaped foods. The comparison between FIG. 1 and FIG. 2 makes it immediately clear that, in FIG. 2, the distance between the channels 11 is very much larger because the flat griddle strips 16 have been inserted. The approximately plate-shaped foods, which are too large for insertion into the channels, can be cooked thereon.

In FIG. 2, the particularly interesting variant thereof shows that the channels 11 and the griddle strips 16 have approximately the same width. In FIG. 2 it can be seen that a plate-shaped food item lies first with one-half of its surface on the griddle strip 16. By virtue of the short distance from the griddle strip 16 to the two adjacent channels 11—transversely to the channels and the griddle strips—it is ensued that excess fat and other liquid flows rapidly into the channel 11, from where such excess fat and liquids flow away.

In FIG. 2 it is very clear that this invention of a griddle top according to the invention permits two different forms of cooking for a plate-shaped food item.

In a variant so far to be classified as “classical”, the plate-shaped food item is laid on the griddle strip until it is well, or very well, cooked in the contacting region and browned on the surface. The less well cooked regions remain between them. This strip-like pattern is classified by some as typical of grilling and therefore classified as a positive quality characteristic.

Others prefer a nutritionally optimum cooking, which is also very clearly comprehensible in FIG. 2; with griddle strips 16 and channels 11 of approximately the same width, the plate-shaped food item can be precooked first on one side in strips and then pushed by precisely one griddle-strip-width, so that now the other half is cooked.

In FIG. 2, it is also clear that the griddle plate 1, according to the present invention in the illustrated embodiment, can also be used for griddling sausages 4, whose diameter is larger than the width of the channels in that they are laid transversely to the channels in a known manner, so that the griddle surface 1 only comes into contact on the horizontal griddle strip 16 between the individual channels 11, and then grilling can take place in a known manner.

FIG. 2 also shows a further, very advantageous embodiment of a griddle top according to the present invention. The griddle plate 1 is surrounded circumferentially at its edge by approximately vertical cover plates 5. Only in the region of the collection channel 3 is no cover plate 5 necessary because the collection channel 3 performs its function.

FIG. 2 makes it clear that, as seen from the heat source 2, a box-like shape is created. The air rising from the heat source 2 collects therein and forms an air cushion with reduced flow rate. The present invention proposes allowing this air cushion to escape via air openings 6, so that further heated air from the heat source 2 can follow and thereby heat the griddle surface 1 more efficiently.

This effect is most effective if—as shown in FIG. 2—the air openings 6 are arranged at two mutually opposite edges. In FIG. 2, the essential air streams effected thereby are represented by way of two large double arrows.

FIG. 2 also shows a further advantageous embodiment. The cover plate 5 mounted at the rear edge of the griddle plate 1, which is not visible, is higher than the collection channel 3 at the front edge. Thereby, not only the griddle plate 1, but also the connected central strips 12 of all channels 11, are inclined so that the drainage of fat and liquid is accelerated. Thereby in the design of the strips 12 of the individual channels 11, greater freedom is possible. The strips no longer necessarily need to be flat—as drawn in FIG. 2—but can also have a slightly curved profile. Despite the fact that the free space between the cylindrical foods to be cooked and the two strips with which the food is in contact is thereby made somewhat smaller, by virtue of its inclination with respect to the horizontal, the drainage of fat and liquid is still ensured.

While only several embodiments of the present invention have been shown and described, it will be obvious to those skilled in the art that many modifications may be made to the present invention without departing from the spirit and scope thereof.

### LIST OF REFERENCE CHARACTERS

1 Griddle plate
2 Heat source below the griddle plate 1
3 Collection channel connect to all channels 11
4 Sausage lying in the channel 11 for griddling
5 Vertical cover plates on the edge of the griddle plate 1
6 Air opening in the cover plates 5
11 Channels in the griddle plate 1
12 Central strip of the channel 11
13 Wall strip of the channel 11 adjacent to the central strip 12
14 Angle between the central strip 12 and the adjacent wall strip 13.
15 Transverse wall closes channel 11
16 Griddle strip between the channels 11

What is claimed is:

1. A griddle top for fast griddling of a plurality of substantially cylindrically-shaped foods, comprising:
a griddle plate capable of lying on, or above, a heat source, said griddle plate having a plurality of channels comprising three substantially flat strips connected to one another at their longitudinal edges for forming a substantially trapezoidal profile for permitting at least one piece of substantially cylindrically-shaped food to come into contact, by at least two mutually-spaced, elongated regions of an outer surface of the at least one piece of substantially cylindrically-shaped food, with one substantially flat strip of said three substantially flat strips of a channel of said plurality of channels.

2. The griddle top for fast griddling of a plurality of substantially cylindrically-shaped foods according to claim 1, wherein at least one channel of said plurality of channels are inclined relative to the horizontal with said at least one channel so inclined passing into a collection channel.

3. The griddle top for fast griddling of a plurality of substantially cylindrically-shaped foods according to claim 1, wherein said three substantially flat strips are defined by a central strip and two adjacent wall strips adjacent opposite sides of said central strip with two angles being formed between an upper surface of said central strip and said two adjacent wall strips with at least one angle of said two angles being greater than 90°.

4. The griddle top for fast griddling of a plurality of substantially cylindrically-shaped foods according to claim 1, wherein said three substantially flat strips are defined by a central strip and two adjacent wall strips adjacent opposite sides of said central strip with two angles being formed between an upper surface of said central strip and said two adjacent wall strips with said two angles having equal magnitude.

5. The griddle top for fast griddling of a plurality of substantially cylindrically-shaped foods according to claim 1, wherein said three substantially flat strips are defined by a central strip and two adjacent wall strips adjacent opposite sides of said central strip with said two adjacent wall strips having approximately equal widths.

6. The griddle top for fast griddling of a plurality of substantially cylindrically-shaped foods according to claim 1, wherein said three substantially flat strips are defined by a central strip and two adjacent wall strips adjacent opposite sides of said central strip with said central strip having a width approximately ¼ or less of the greater width of the widths of said two adjacent wall strips.

7. The griddle top for fast griddling of a plurality of substantially cylindrically-shaped foods according to claim 1, wherein said three substantially flat strips are defined by a central strip and two adjacent wall strips adjacent opposite sides of said central strip and further including one curved region between each adjacent wall strip of said two adjacent wall strips and said central strip.

8. The griddle top for fast griddling of a plurality of substantially cylindrically-shaped foods according to claim 1, wherein at least two channels of said plurality of channels have different widths.

9. The griddle top for fast griddling of a plurality of substantially cylindrically-shaped foods according to claim 1, wherein at least one channel of said plurality of channels has portions having different widths along a length of said at least one channel.

10. The griddle top for fast griddling of a plurality of substantially cylindrically-shaped foods according to claim 1, wherein at least one channel of said plurality of channels has a width which is largest in a central region of said at least one channel.

11. The griddle top for fast griddling of a plurality of substantially cylindrically-shaped foods according to claim 1, wherein all channels of said plurality of channels are oriented parallel to one another.

12. The griddle top for fast griddling of a plurality of substantially cylindrically-shaped foods according to claim 1, further comprising a cover plate for removable attachment to an underside of said griddle plate for adaption to the heat source.

13. The griddle top for fast griddling of a plurality of substantially cylindrically-shaped foods according to claim 1, further comprising circumferential vertical cover plates attachable on outer edges of said griddle plate.

14. The griddle top for fast griddling of a plurality of substantially cylindrically-shaped foods according to claim 1,

15. A griddle top for fast griddling of a plurality of substantially cylindrically-shaped foods, comprising:
a griddle plate capable of lying on, or above, a heat source, said griddle plate having a plurality of channels comprising three substantially flat strips connected to one another at their longitudinal edges for forming an upwardly open profile for permitting at least one piece of substantially cylindrically-shaped food to come into contact, by at least two mutually-spaced, elongated regions of an outer surface of the at least one piece of substantially cylindrically-shaped food, with one substantially flat strip of said three substantially flat strips of a channel of said plurality of channels.

16. The griddle top for fast griddling of a plurality of substantially cylindrically-shaped foods according to claim 15, wherein said upwardly open profile is substantially trapezoidal.

17. The griddle top for fast griddling of a plurality of substantially cylindrically-shaped foods according to claim 16, further comprising downwardly facing trapezoidal strips, or segments of said downwardly facing trapezoidal strips, are located at an edge of said griddle plate and oriented perpendicular to said griddle plate.

18. The griddle top for fast griddling of a plurality of substantially cylindrically-shaped foods according to claim 16, further comprising downwardly facing trapezoidal strips, or segments of said downwardly facing trapezoidal strips, are located within said griddle plate and oriented perpendicular to said griddle plate.

19. The griddle top for fast griddling of a plurality of substantially cylindrically-shaped foods according to claim 15, further comprising substantially flat griddle strips inserted between channels of said plurality of channels.

20. The griddle top for fast griddling of a plurality of substantially cylindrically-shaped foods according to claim 19, wherein said substantially flat griddle strips are approximately as wide as said plurality of channels and are oriented parallel to one another.
